(19) United States
(12) Patent Application Publication
(10) Pub. No.: US 2004/0117626 A1
(43) Pub. Date: Jun. 17, 2004

(54) KEY EXCHANGE BASED ON DSA TYPE CERTIFICATES

(75) Inventor: ASHOT ANDREASYAN, SAN JOSE, CA (US)

Correspondence Address: DVA/PIONEER RESEARCH CENTER USA, INC., INTELLECTUAL PROPERTY DEPARTMENT, 2355 MAIN STREET, SUITE 200, IRVINE, CA, 92614, US

(73) Assignee: PIONEER RESEARCH CENTER USA, INC., SAN JOSE, CA (US)

(21) Appl. No.: 10/605,173

(22) Filed: Sep. 12, 2003

(51) Int. Cl. H04L 9/00

(52) U.S. Cl. 713/175

(57) ABSTRACT

A first certificate is provided from a first peer to a second peer. The first certificate includes a plurality of first parameters. A first exponentiation operation is performed to generate a first public key from the second peer using the plurality of first parameters and the first private key from the second peer. A second certificate and the first public key from the second peer are provided to the first peer. The second certificate comprises a plurality of second parameters. A second exponentiation operation is performed to generate a shared secret key for the second peer using at least one parameter from the plurality of first parameters. A third exponentiation operation is performed to generate the shared secret key for the first peer using the first public key from the second peer and a private key from the first peer.

### BACKGROUND OF INVENTION

1. [Field of the Invention]

The present invention relates generally to key exchange protocols, and more particularly, to key exchange protocols that use DSA type certificates.

2. [Background of the Invention]

Currently, two key exchange protocols are mostly used on the Internet: Diffie-Hellman (DH) and RSA (named for its creators Rivest, Shamir, and Adleman). Diffie-Hellman key exchange algorithm is used to generate a shared secret key between two peers. RSA is a popular public-key algorithm and can be used for both encryption and digital signatures. RSA encryption is used to transfer a master secret key to a peer. DSA (Digital Signature Algorithms) is another public-key algorithm that is used as part of the Digital Signature Standard (DSS). Unlike RSA, DSA is not used for encryption, but only for digital signatures. This invention relates to key exchange protocols (i.e., Internet Key Exchange (IKE), Secure Sockets Layer (SSL), etc.), which contain a certificate (e.g., X.509 certificate) inside key exchange protocols to authenticate messages between an initiator and responder. Authentication is a process of confirming an identity. It involves the confident identification of one entity (i.e., initiator) to another entity (i.e., responder).

Authentication over networks can take many forms. Certification is one way of supporting the authentication. A certificate is an electronic document used to identify an entity (i.e., a server, an individual, a company) and to associate that identity with a public key. Like a driver's license, a passport, or other commonly used personal identification, a certificate provides generally recognized proof of a person's identity. Public-key cryptography uses certificates to address the problem of impersonation. Certificates help prevent the use of fake public keys for impersonation. Only the public key certified by the certificate authority will work with the corresponding private key, possessed by the entity.

To authenticate key exchange messages, initiator and responder send its certificates with a key exchange message using key exchange protocols (i.e., Internet Key Exchange (IKE), Secure Sockets Layer (SSL)). Authentication is an essential element of network security within most intranets or extranets. One of the forms of authentication is certificate-based authentication. Authentication based on certificates is part of a key exchange protocol (e.g., SSL protocol). It is contemplated that other protocols such as IKE or any other key exchange protocol can be used in a certification and authentication process. One example of the certificate-based authentication is when the initiator (i.e., client) digitally signs a randomly generated piece of data and sends both the certificate and the signed data across a network. The responder (i.e., server) uses techniques of public-key cryptography to validate the signature and confirm the validity of the certificate.

The key exchange protocol accommodated with X.509 certificates provides an authentication across networks. Although no particular algorithms are specified for either security or authentication, most key exchange protocol messages are sent with RSA and DSA type certificates.

When a key exchange protocol uses a DSA type certificate (i.e., X.509 certificate), the DH key exchange algorithm is used to obtain the session key (e.g., shared secret key). In the DH key exchange, both the initiator and responder are passed with DH public numbers and both sides then calculate the shared secret number. This algorithm demands four (4) exponentiation operations to obtain the session key.

The present invention provides a method, that eliminates the use of the DH key exchange algorithm and reduces the number of exponentiation operations, used to obtain the shared secret key, when a key exchange protocol uses the DSA type certificate (e.g., X.509 certificate).

### SUMMARY OF INVENTION

In accordance with one embodiment of the present invention, a method that minimizes the number of exponentiation operations in key exchange based on DSA type certificates is disclosed. The method allows saving some computational resources compared to the other key exchange algorithms (i.e., Diffie-Hellman algorithm). In the DH key exchange, for example, two exponentiation operations are needed in each side of the peers to get a DH-shared number. The present invention discloses a method that uses DSS parameters in a DSA type certificate to generate a shared secret key in the initiator's side by one and in the responder side by two exponentiation operations. The method can work in IKE, SSL/TLS or any type of key exchange protocol that uses a DSA type certificate (i.e., X.509 certificate). This method eliminates the need to do DH key exchange and therefore, optimizes the number of exponentiation operations.

### BRIEF DESCRIPTION OF DRAWINGS

FIG. 1 is a block diagram illustrating a computer system in which one embodiment of the present invention can be practiced.

FIG. 2 is a flow chart diagram illustrating an authentication process in which one embodiment of the present invention can be practiced.

FIG. 3 is a block diagram illustrating a sample of a certificate structure in which one embodiment of the present invention can be practiced.

FIG. 4 is a diagram illustrating a sample of a certificate hierarchy in which one embodiment of the present invention can be practiced.

FIG. 5 is a flow chart diagram illustrating how a shared secret key is obtained according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown in order not to obscure the understanding of this description.

[System Level]

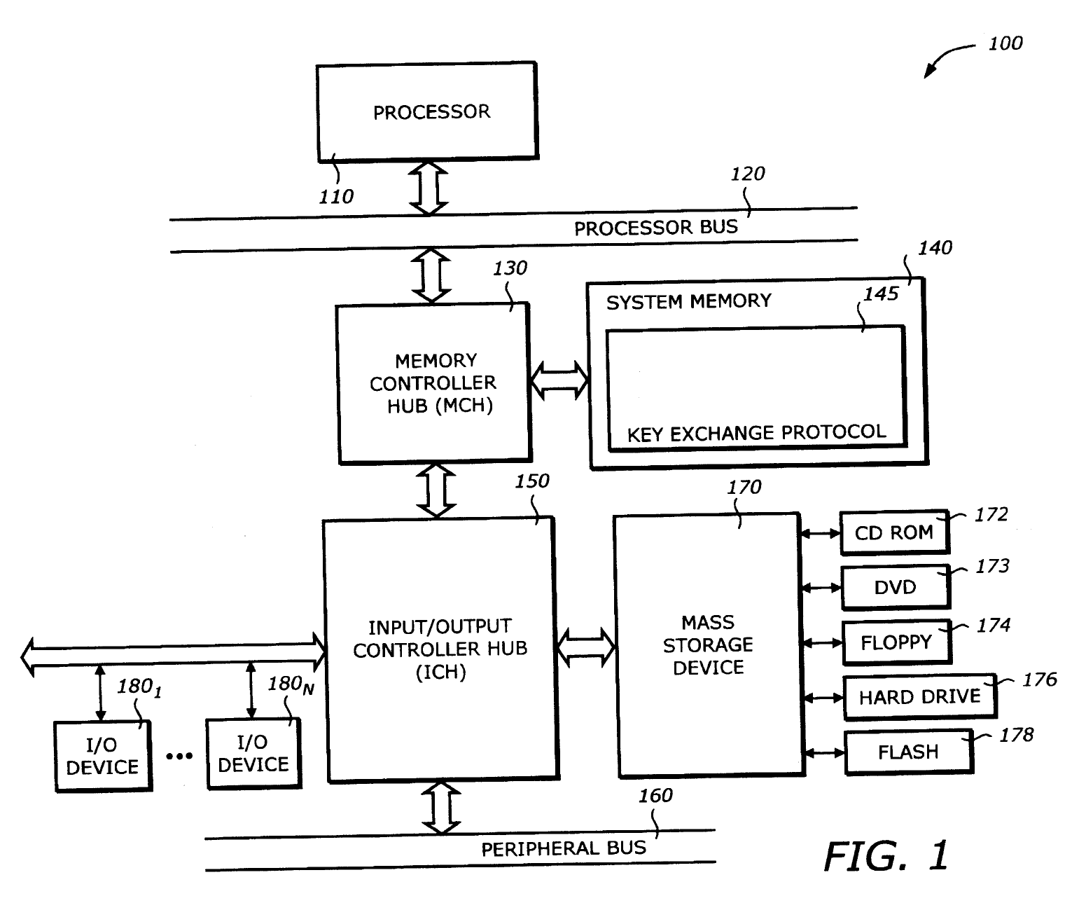

FIG. 1 is a diagram illustrating a processor system 100 in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code (i.e., code to calculate a shared key) and data. The system memory 140 is typically implemented with dynamic random access memory (DRAM) or static random access memory (SRAM). The system memory 140 may include program code or code segments implementing one embodiment of the invention. The system memory includes a user interface management 145. Any one of the elements of the user interface management 145 may be implemented by hardware, software, firmware, microcode, or any combination thereof. The system memory 140 may also include other programs or data, which are not shown, such as an operating system. The user interface management 145 contains program code that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The processor readable or accessible medium or machine readable or accessible medium may include any medium that can store, transmit, or transfer information. Examples of the processor readable or machine accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, causes the machine to perform the operations described in the following. The machine accessible medium may also include program code embedded therein. The program code may include machine-readable code to perform the operations described in the following. The term data here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, an argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

[Using A Certificate to Authenticate an Entity to Another Entity]

A certificate is an electronic document used to identify an identity (i.e., server, individual, company) and to associate that identity with a public key. Public-key cryptography uses certificates to address the problem of impersonation. Authentication, on the other hand, is the process of confirming an identity. Authentication involves the confident identification of one party by another party. Authentication over networks can take many forms. Certificates are one way of supporting authentication.

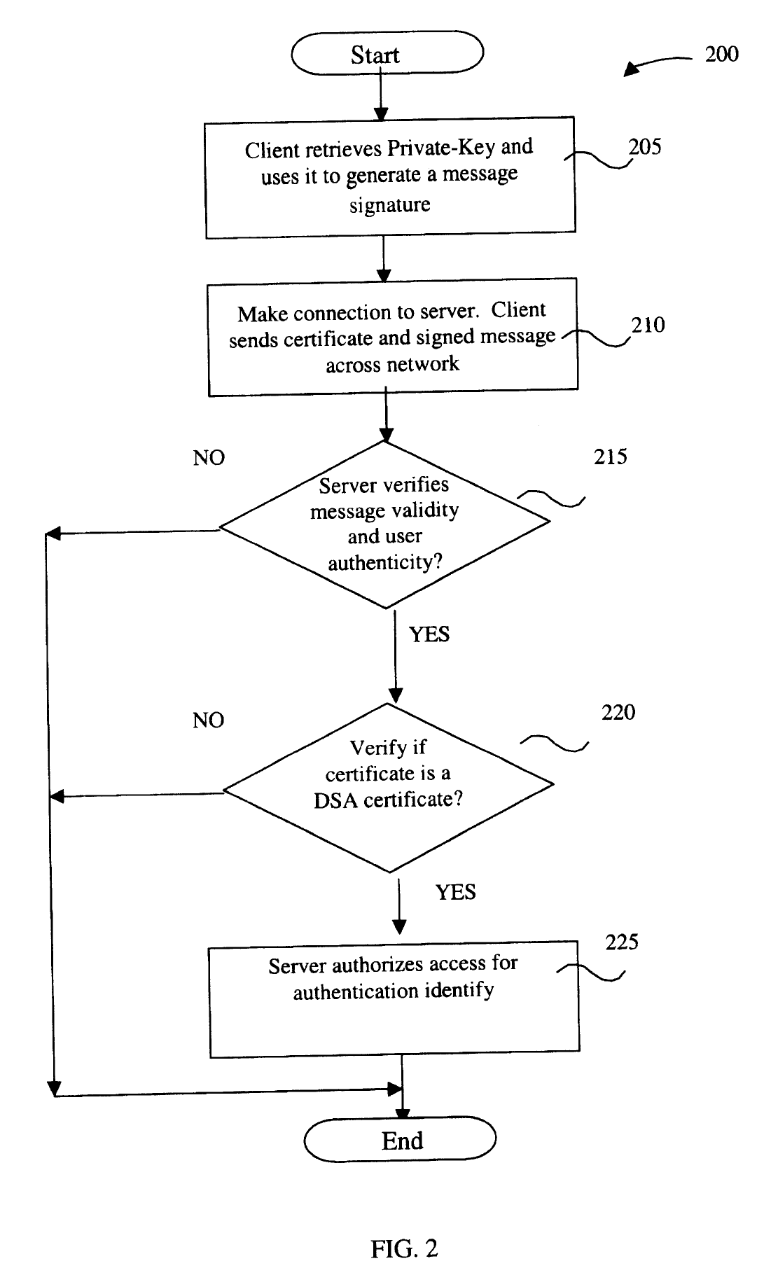

FIG. 2 illustrates an authentication process 200 using a certificate to authenticate an entity in which one embodiment of the present invention can be practiced. For purposes of illustration, the authentication process is performed over a network and uses certificates and SSL key exchange protocol. However, it is contemplated that an authentication process may be performed over any kind of network (i.e., wireless, blue-tooth, Wi-Fi networks). Network interactions typically take place between a client and a server. Client authentication refers to the confident identification of a client by a server, and server authentication refers to the confident identification of a server by a client. Client authentication is an essential element of network security within most intranets or extranets. Even though the present invention may be used in numerous type of key exchange protocols (i.e., Internet Key Exchange (IKE), Secure Sockets Layer (SSL), etc.), for the purpose of general discussion, only SSL key exchange protocol of certificate-based authentication is discussed here.

SSL protocol is a set of rules governing server authentication, client authentication, and encrypted communication between servers and clients. The SSL security protocol provides data encryption, server authentication, message integrity, and client authentication for a TCP/IP connection. As part of an initial handshake process, a server presents its certificates to the client to authenticate the server's identity. The authentication process uses Public Key Encryption and Digital Signatures to confirm that the server is in fact who the server claims to be. Once the server has been authenticated, the client and server use techniques of Symmetric-Key Encryption, which is very fast, to encrypt all the information they exchange for the remainder of the session and to detect any tampering that may have occurred. Servers may optionally be configured to require client authentication as well as server authentication. In this case, after server authentication is successfully completed, the client presents its certificate to the server to authenticate the client's identity before the encrypted SSL session can be established. It is noted that at the present time, SSL comes into two strengths, 40-bit and 128-bit, which refers to the length of the session key generated by every encrypted transaction. The longer the key, the more difficult it is to break the encryption code.

Client authentication based on certificates is part of SSL protocol. The client digitally signs a randomly generated piece of data and sends both the certificate and the signed data across the network. The server uses techniques of public-key cryptography to validate the signature and confirm the validity of the certificate. The content of certificates supported by many software companies is organized according to the X.509 certificate specification.

In one embodiment, the process 200 uses a certificate to authenticate a user's identity to a server. At step 205 client retrieves the private key (which can be stored in FLASH memory, smart cards, on hard drive, etc.) and uses it to generate a message signature at step 210. The client sends the certificate and signed message across the network (Step 210). The server then verifies the message validity by verifying the message signature and client authenticity by verifying the client certificate (Step 215). If one of the verifications does not pass, the process is terminated. If all of the verifications pass, the server checks whether the certificate is a DSA type of certificate (Step 220). If the certificate is not a DSA type certificate, the process is then terminated. The process continues when the server authorizes access for authentication identity (Step 225). The process 200 is then terminated. It is contemplated that the authentication of key exchange messages process can be done with any kind of key exchange protocol, which uses a DSA type certificate (e.g., X.509 type certificate). One important part of X.509 is its structure for public-key certificates. Each user (e.g., an initiator and a responder) has a distinct name and a signed certificate that is assigned by a trusted certification authority. The signed certificate comprises, inter alia, the user's public key.

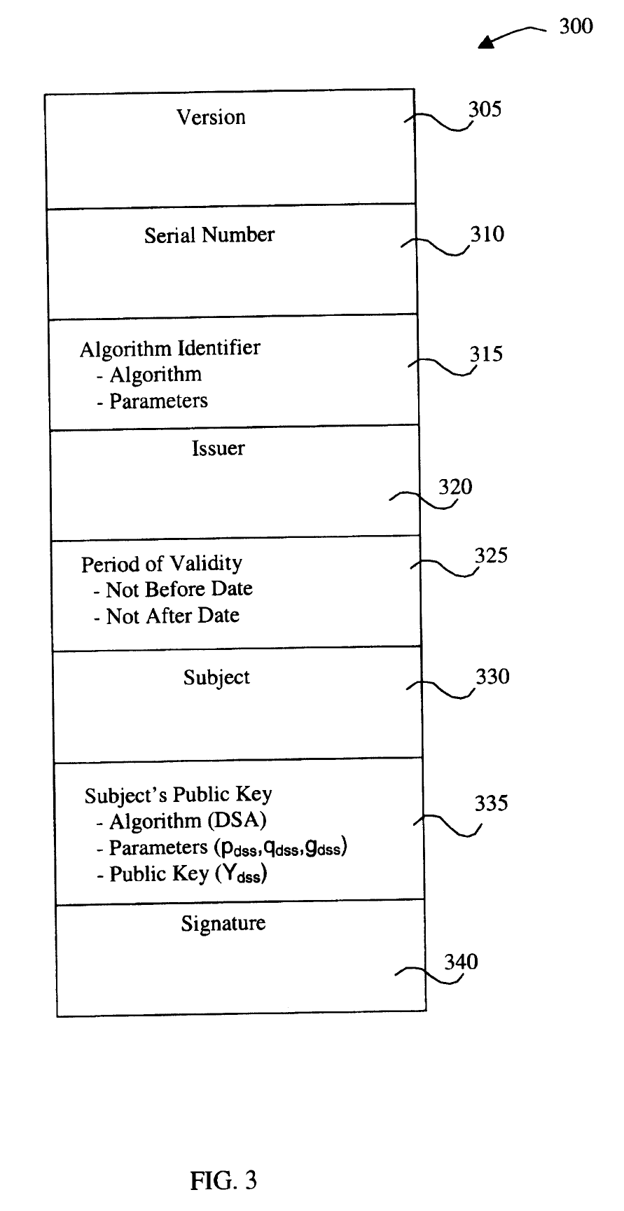

FIG. 3 illustrates an X.509 certificate 300 in which one embodiment of the present invention can be practiced. The X.509 certificate may comprise two sections. One is a data section, which includes several fields (305-340) and the other is a signature section. The data section in a certificate comprises the following fields. A Version field 305 identifies a certificate format. A Serial Number field 310 includes a unique number assigned by a certification authority (CA). Another field, Algorithm Identifier field 315, is used to identify the algorithm used to sign the certificate together with any necessary parameters. Issuer name (i.e., name of the certification authority) may be included in Issuer field 320. Yet another field, Period of Validity field 325, may be used to indicate the period of validity of the certificate. Subject field 330 is another field that shows the name of the user (i.e., client, server). The certificate binds a distinguished name in the certificate subject to a public key. This name is a series of name-value pairs that uniquely identifies the user. The name includes user ID, email address, the user's common name, organization, and country, etc. The Subject's Public Key field 335 comprises information such as the name of the algorithm, any necessary parameters, and the public key. The Signature field 340 is provided to include the signature. The signature section includes the cryptographic algorithm, or cipher, used by the issuing certificate authority to create its own digital signature and the certificate authority's digital signature. The digital signature is obtained by hashing all of the data in the certificate together and encrypting it with the certificate authority's private key.

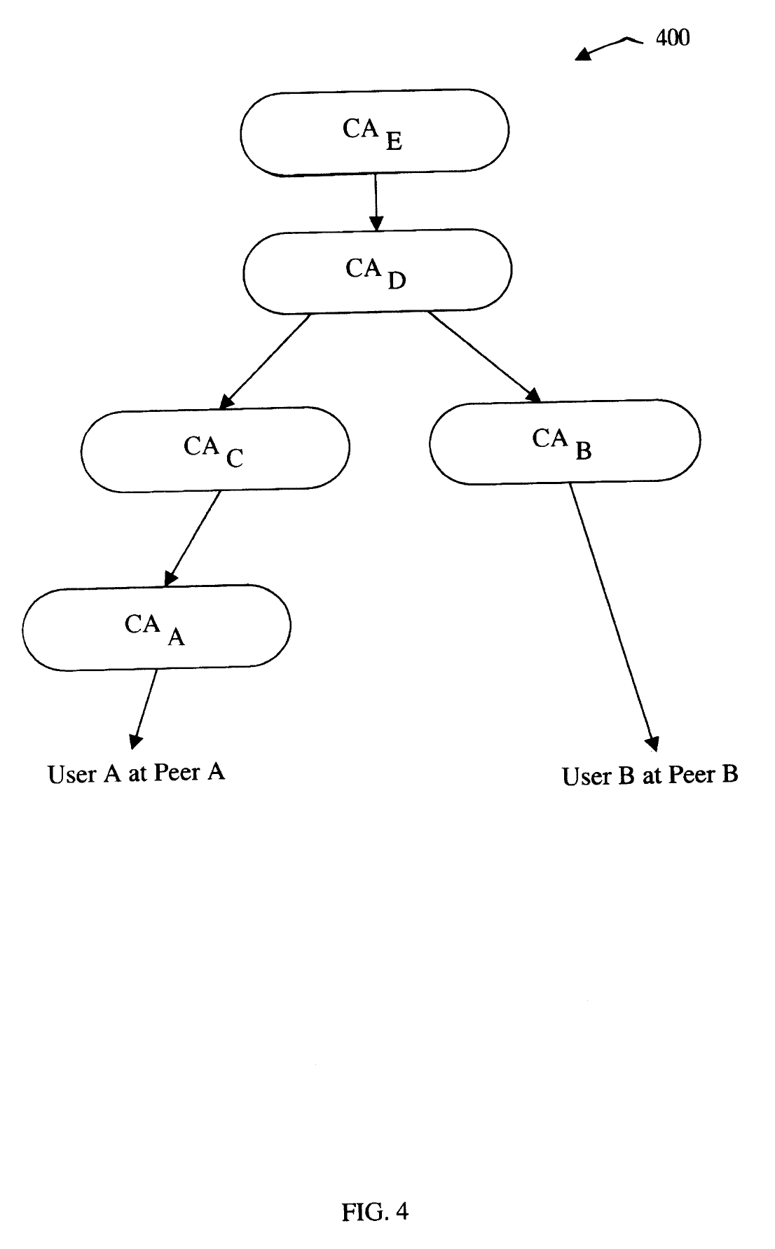

FIG. 4 illustrates a sample certification hierarchy in which one embodiment of the present invention can be practiced. The certification process 400 begins when user A at peer A initiates a communication with user B at peer B. User A first gets his/her certificate for a database. Then, user A verifies its authenticity. If both users share the same certificate authority (CA), user A simply verifies the certificate authority's signature on user B's certificate. However, if both users use different certificate authority, process 400 illustrates how user A uses these certificates to verify user B's certificate. It is noted that a certificate authority is a trusted third party who cryptographically signs and then issues digital certificates (e.g., X.509 certificate). The CA has its own public/private key pair. The public key is made available to each user through CA certificate. This public key allows a user to verify any peer certificate signed by the CA.

In process 400, user A's certificate is certified by CA_{A} and user B's certificate is certified by CA_{B}. User A knows CA_{A}'s public key. CA_{C} has a certificate signed by CA_{A}, so user A can verify that. CA_{D} has a certificate signed by CAC. CA_{B} has a certificate signed by CA_{D}. And user B's certificate is signed by CA_{B}. By moving up the certification tree to a common point, in this case CA_{D}, and then down to user B, user A can verify user B's certificate.

In an IKE, SSL, or any kind of key exchange using DSA type of certificate, DH key exchange is used. In DH key exchange, DH public numbers are passed to both sides (i.e., both peers) to calculate a shared secret number. To obtain a session key, this DH algorithm, however, demands four (4) exponentiation operations. When DH key exchange is used, the server can either supply a certificate containing fixed DH parameters or use the client key exchange message to send a set of temporary DH parameters signed with a DSS certificate. Temporary parameters are hashed with random values before signing to ensure that attackers do not replay old parameters. In either case, the client can verify the certificate or signature to ensure that the parameters belong to the server.

In the case where the client has a certificate containing fixed DH parameters, the certificate contains the information required to complete the key exchange and the client and server will generate the same DH result. In the case where the client has a standard DSS certificate, it sends a set of temporary parameters to the server in the client key exchange message, then optionally uses a certificate to verify a message to authenticate itself. The present invention does not use the DH parameters but the DSS parameters. In addition, the present invention also uses the certificate public key to obtain the shared secret key at the server. This way, one exponentiation operation is eliminated since a Diffie-Hellman public key from the client is not needed to obtain the shared secret key at the server.

[Diffie-Hellman Key Exchange Protocol]

Diffie-Hellman uses a pair of keys: a public key and a private key. However, Diffie-Hellman does not perform encryption/decryption or signatures, as do the other public key systems. As shown below, DH implements a means to generate a shared key.

To authenticate the identity of the initiator A (peer A) and the responder B (peer B) using Diffie-Hellman (DH), the initiator A and responder B may use DSA (e.g., X.509) certificate in key exchange protocols. The key exchange protocol may be an IKE, SSL, or any type of key exchange protocol, where certificates are passing between initiator and responder. In the Diffie-Hellman (DH) key exchange algorithm, the DH public number is passed to both the initiator and responder. Both sides calculate the shared secret number. This algorithm demands four exponentiation operations (two operations from each side) to obtain the session key.

The following is how the DH key exchange works when messages are authenticated by a DSA algorithm (by assuming that all these messages are signed by peer's DSA private key). It is noted that the DH parameters comprise a public key, p_{dh} and g_{dh} parameters. At peer A the public key of

| Peer A | Peer B |
|---|---|
| (1) Y_{Adh} = g_{dh}\hat{ }X_{Adh} mod p_{dh} | (2) Y_{Bdh} = g_{dh}\hat{ }X_{Bdh} mod p_{dh} |
| Cert(Y_{Adss}, p_{dss}, q_{dss}, g_{dss}), Y_{Adh} | Cert(Y_{Bdss}, p_{dss}, q_{dss}, g_{dss}), Y_{Bdh} |
| 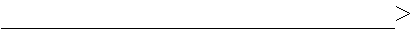 | 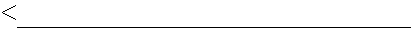 |
| (4) Initiator A calculates DH shared | (3) Responder B calculates DH |
| key | shared key |
| Y_{DHSK} = Y_{Bdh}\hat{ }X_{Adh} mod p_{dh} | Y_{DHSK} = Y_{Adh}\hat{ }X_{Bdh} mod p_{dh} |
| = g_{dh}\hat{ }(X_{Bdh} * X_{Adh}) mod p_{dh} | = g_{dh}\hat{ }(X_{Adh} * X_{Bdh}) mod p_{dh} |

Where Y_{Adh} is a Diffie-Hellman public key of peer A

X_{Adh} is a DH private key of peer A

Y_{Bdh} is a DH public key of peer B

X_{Bdh} is a DH private key of peer B

Y_{Adss} is a DSS public key of certificate of peer A

Y_{Bdss} is a DSS public key of certificate of peer B

g_{dh} is a DH generator for GF

p_{dh} is a DH prime number

p_{dss} is a prime number from DSS, which comes from X.509 certificate

q_{dss} is a prime number from DSS, which comes from X.509 certificate

g_{dss} is a generator for GF (p_{dss}), which comes from X.509 certificate

Y_{DHSK} is a DH shared key

It is noted that all of these parameters are defined in FIPS-186 “DSS Digital Signature Standard” May 14, 1994.

\hat{ }=exponentiation operation

*=multiplication operation

Using a DH algorithm in key exchange based on a DSA type of certificate, peer A first calculates its DH public key Y_{Adh} using the first exponentiation operation. The calculated public key Y_{Adh} is sent together with peer A certificate to peer B. The certificate of peer A includes a public key Y_{Adss}, and parameters p_{dss}, q_{dss} and g_{dss}. Peer B then performs a second exponentiation operation to obtain its DH public key Y_{Bdh}. The public key Y_{Bdh} is sent together with peer B certificate to peer A. At peer B, a third exponentiation operation is performed to obtain the shared key for peer B. The DH shared key is obtained using the DH parameter p_{dh}, the DH public key Y_{Adh} (sent from peer A) and peer B private key X_{Bdh}. To obtain the DH shared for peer A, a fourth exponentiation operation is performed. The shared key is obtained using the DH parameter p_{dh} the DH public key Y_{Bdh} (sent from peer B), and peer A private key X_{Adh}. As shown above, to obtain the same shared key Y_{DHSK}, four exponentiation operations are needed.

[Key Exchange Based on DSA Type Certificates]

The following is an illustration of a method of key exchange based on a DSA type certificate according to one embodiment of the present invention. To optimize the number of the exponentiation operation, the present invention uses DSS parameters from the X.509 certificate for the key exchange. The DSS parameters comprise p_{dss}, q_{dss}, and g_{dss}. Here also all messages are signed by peers DSA private key.

The following is how the key exchange in the present invention works:

| Peer A | Peer B |
|---|---|
| Cert(Y_{Adss}, p_{dss}, q_{dss}, g_{dss}) | (1) Y_{R} = g_{dss}\hat{ }X_{R} mod p_{dss} |
| | Cert(Y_{Bdss}, p_{dss}, q_{dss}, g_{dss}), Y_{R} |
| 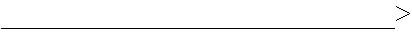 | 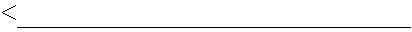 |
| (3) Initiator A calculates shared secret | (2) Responder B calculates shared |
| key | secret key |
| Y_{SSK} = Y_{R}\hat{ }X_{Adss} mod p_{dss} | Y_{SSK} = Y_{Adss}\hat{ }X_{R} mod p_{dss} |
| = g_{dss}\hat{ }(X_{R} * X_{Adss}) mod p_{dss} | = g_{dss}\hat{ }(X_{Adss} * X_{R}) mod p_{dss} |

As shown above, public-key cryptography may be used to authenticate key exchange messages. The host keeps a file of every user's public key; all users keep their own private keys.

The following is a description of a DSA algorithm. The algorithm uses the following parameters:

Where Y_{Adss} is a DSS public key from certificate of peer A

X_{Adss} is a DSS private key corresponding to Y_{Adss} from certificate of peer A

Y_{Bdss} is a DSS public key from certificate of peer B

X_{Bdss} is a DSS private key corresponding to Y_{Bdss} from certificate of peer B

Y_{R} is the one-time public key of peer B

X_{R} is the one-time private key of peer B (1<X_{R}<q_{dss}−1)

Y_{SSK} is a shared secret key

p_{dss} is a prime number L bits long, where L ranges from 512 to 1024 where L is any multiple of 64.

q_{dss} is a 160-bit prime factor of P_{dss}−1.

g_{dss}=h\hat{ }(p_{dss}−1)/q_{dss} mod p_{dss}, where h is any number less than p_{dss}−1 such that h\hat{ }(p_{dss}−1)/ q_{dss} mod p_{dss} is greater than 1.

It is noted that the three parameters p_{dss}, q_{dss}, and g_{dss}, are public and can be common across a network of users.

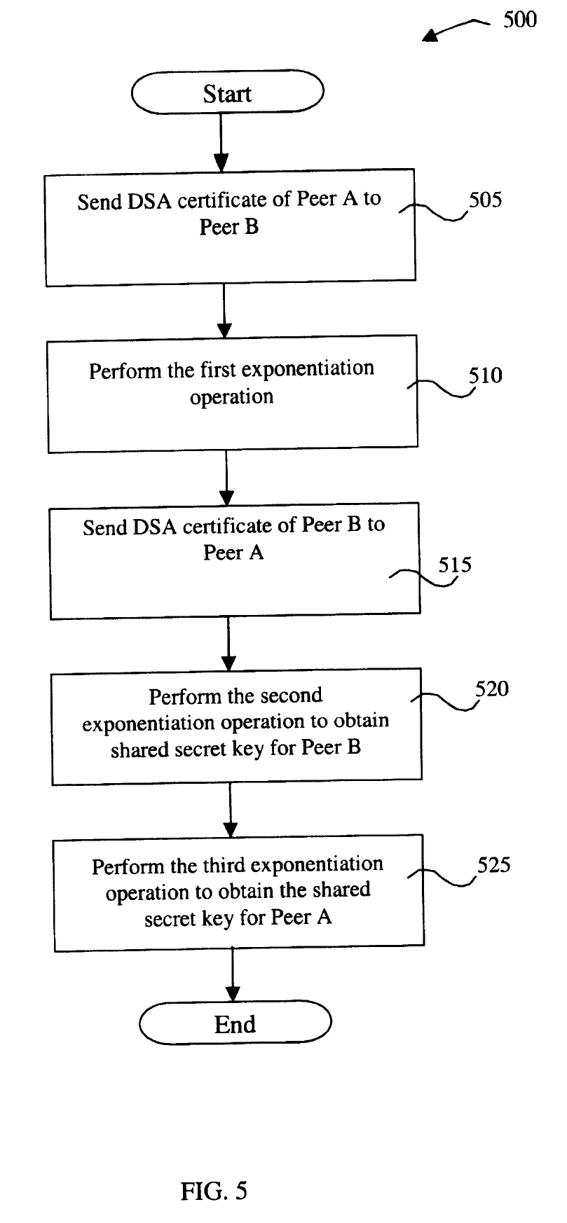

FIG. 5 illustrates a process 500 for calculating a shared key in which one embodiment of the present invention can be practiced. At step 505, process 500 sends a DSA certificate of peer A over to peer B. The certificate includes a public key Y_{Adss}, and a plurality of parameters such as p_{dss}, a prime number from DSA standard, which comes from X.509 certificate; q_{dss}, a prime number from DSA standard, which comes from X.509 certificate; and g_{dss}, generator for GF (p_{dss}) which comes from X.509 certificate. The process 500 continues at step 510 to perform the first exponentiation operation to obtain a one time public key of peer B, Y_{R}. As shown in the equation above, Y_{R} is obtained using the parameters of the certificate (i.e., pdss g_{dss} q_{dss}) sent from peer A and randomly generated X_{R}. The process then sends a DSA certificate of peer B together with the one time public key of peer B, Y_{R} over to peer A (step 515). At peer B, the second exponentiation is performed to obtain the shared secret key Y_{SSK} for peer B (step 520). Y_{SSK} is obtained using the public key Y_{Adss}, parameters of the certificate sent from peer A (i.e., p_{dss}, g_{dss}) and peer B one time private key X_{R}. At peer A, the process continues at step 525 to perform the third exponentiation operation to obtain the shared secret key for peer A. The shared secret key is calculated using peer B one time public key Y_{R}, peer A private key X_{Adss}, and parameter p_{dss}, g_{dss}, of the certificate. The process 500 is then terminated. As shown above, in order to obtain a shared secret key for both sides, the key exchange in one embodiment of the present invention uses only three exponentiation operations.

While certain embodiments are illustrated in the drawings and have been described herein, it will be apparent to those skilled in the art that many modifications can be made to the embodiments without departing from the inventive concepts described.

1. A method for generating a shared key comprising:
providing a first certificate from a first peer to a second peer, the first certificate including a plurality of first parameters;
performing a first exponentiation operation to generate a first public key from the second peer using at least one parameter of the plurality of first parameters and a first private key from the second peer;
providing a second certificate and the first public key from the second peer to the first peer, the second certificate comprising a plurality of second parameters;
performing a second exponentiation operation to generate a shared secret key for the second peer using at least one parameter from the plurality of first parameters;
performing a third exponentiation operation to generate the shared secret key for the first peer using the first public key from the second peer and a private key from the first peer.

2. The method according to claim 1 wherein the first certificate is a DSA type certificate.

3. The method according to claim 2 wherein the first and second parameters comprise a prime number p_{dss}, a prime number q_{dss} a generator g_{dss} and a public key for the first and second peers, respectively.

4. The method according to claim 3 wherein the first exponentiation operation to generate the first public key is Y_{R}=g_{dss}\hat{ }X_{R} mod p_{dss} where X_{R} is a one-time private key from the second peer.

5. The method according to claim 4 wherein the second exponentiation operation to generate the shared secret key for the second peer is Y_{SSK}=Y_{Adss}\hat{ }X_{R} mod p_{dss} where Y_{Adss} is a DSS public key from certificate of peer A.

6. The method according to claim 5 wherein Y_{Adss}=g_{dss}\hat{ }X_{Adss} mod p_{dss} where X_{Adss} is a DSS private key from certificate of peer A.

7. The method according to claim 5 wherein the third exponentiation operation to generate the shared secret key for the first peer is Y_{SSK}=YR\hat{ }X_{Adss} mod p_{dss} where X_{Adss} is a DSS private key from certificate of peer A.

8. The method according to claim 1 wherein the first and second certificates are sent to the second and first peers, respectively, over a wireless network.

9. An article of manufacture comprising:
a machine accessible medium including data that, when accessed by a machine, causes the machine to perform operations comprising:
providing a first certificate from a first peer to a second peer, the first certificate including a plurality of first parameters;
performing a first exponentiation operation to generate a first public key from the second peer using the plurality of first parameters and the first private key from the second peer;
providing a second certificate and the first public key from the second peer to the first peer, the second certificate comprising a plurality of second parameters;
performing a second exponentiation operation to generate a shared secret key for the second peer using at least one parameter from the plurality of first parameters;
performing a third exponentiation operation to generate the shared secret key for the first peer using the first public key from the second peer and a private key from the first peer.

10. The article of manufacture according to claim 9 wherein the first certificate is a DSA type certificate.

11. The article of manufacture according to claim 10 wherein the first and second parameters comprise a prime number p_{dss}, a prime number q_{dss}, a generator g_{dss} and a public key for the first and second peers, respectively.

12. The article of manufacture according to claim 11 wherein the first exponentiation operation to generate the first public key is Y_{R}=g_{dss}\hat{ }XR mod p_{dss} where X_{R} is a one-time private key from the second peer.

13. The article of manufacture according to claim 12 wherein the second exponentiation operation to generate the shared secret key for the second peer is Y_{SSK}=Y_{Adss}\hat{ }X_{R} mod p_{dss} where Y_{Adss} is a DSS public key from certificate of peer A.

14. The article of manufacture according to claim 13 wherein Y_{Adss}=g_{dss}\hat{ }X_{Adss} mod p_{dss} where X_{Adss} is a DSS private key from certificate of peer A.

15. The article of manufacture according to claim 13 wherein the third exponentiation operation to generate the shared secret key for the first peer is Y_{SSK}=Y_{R}\hat{ }X_{Adss} mod p_{dss} where X_{Adss} is a DSS private key from certificate of peer A.

16. The article of manufacture according to claim 9 wherein the first and second certificates are sent to the second and first peers, respectively, over a wireless network.

17. A system comprising:
a processor; and
a memory coupled to the processor, the memory containing program code that, when executed by the processor, causes the processor to:
provide a first certificate from a first peer to a second peer, the first certificate including a plurality of first parameters;
perform a first exponentiation operation to generate a first public key from the second peer using the plurality of first parameters and the first private key from the second peer;
provide a second certificate and the first public key from the second peer to the first peer; the second certificate comprising a plurality of second parameters;
perform a second exponentiation operation to generate a shared secret key for the second peer using at least one parameter from the plurality of first parameters;
performing a third exponentiation operation to generate the shared secret key for the first peer using the first public key from the second peer and a private key from the first peer.

18. The system according to claim 17 wherein the first certificate is a DSA type certificate.

19. The system according to claim 18 wherein the first and second parameters comprise a prime number p_{dss}, a prime number q_{dss}, a generator g_{dss} and a public key for the first and second peers, respectively.

20. The system according to claim 19 wherein the first exponentiation operation to generate the first public key is Y_{R}=g_{dss}\hat{ }X_{R} mod p_{dss} where X_{R} is a one-time private key from the second peer.

21. The system according to claim 20 wherein the second exponentiation operation to generate the shared secret key for the second peer is Y_{SSK}=Y_{dss}\hat{ }X_{R} mod p_{dss} where Y_{Adss} is a DSS public key from certificate of peer A.

22. The system according to claim 21 wherein Y_{Adss}=g_{dss}\hat{ }X_{Adss} where X_{Adss} is a DSS private key from certificate of peer A.

23. The system according to claim 21 wherein the third exponentiation operation to generate the shared secret key for the first peer is Y_{SSK}=YR\hat{ }X_{Adss} mod p_{dss} where X_{Adss} is a DSS private key from certificate of peer A.

24. The system according to claim 17 wherein the first and second certificates are sent to the second and first peers, respectively, over a wireless network.

25. A method comprising:
receiving a first certificate including a plurality first parameters;
performing a first exponentiation operation to generate a first public key using at least one parameter of the plurality of first parameters and a first private key;
receiving a second certificate and the first public key, the second certificate including a plurality of second parameters;
performing a second exponentiation operation to generate a first shared secret key using at least one parameter from the plurality of first parameters;
performing a third exponentiation operation to generate a second shared secret key using the first public key and a private key.

26. The method according to claim 25 wherein the first certificate is a DSA type certificate.

27. The method according to claim 26 wherein the first and second parameters each comprises a prime number p_{dss}, a prime number q_{dss}, a generator g_{dss} and a public key.

28. The method according to claim 27 wherein the first exponentiation operation to generate the first public key is Y_{R}=g_{dss}\hat{ }X_{R} mod P_{dss} where X_{R} is a one-time private key.

29. The method according to claim 28 wherein the second exponentiation operation to generate the first shared secret key for the second peer is Y_{SSK}=Y_{Adss}\hat{ }X_{R} mod p_{dss} where Y_{Adss} is a DSS public key.

30. The method according to claim 29 wherein Y_{Adss}=g_{dss}\hat{ }X_{Adss} mod p_{dss} where X_{Adss} is a DSS private key.

31. The method according to claim 29 wherein the third exponentiation operation to generate a second shared secret key is Y_{SSK}=Y_{R}\hat{ }X_{Adss} mod p_{dss} where X_{Adss} is a DSS private key.

32. The method according to claim 25 wherein the first and second certificates are sent to the second and first peers, respectively, over a wireless network.
